(19) United States
(12) Patent Application Publication
(10) Pub. No.: US 2024/0033990 A1
(43) Pub. Date: Feb. 1, 2024

(54) SYSTEM AND METHOD FOR PROCESSING FIBER-REINFORCED COMPOSITES IN ADDITIVE MANUFACTURING

(71) Applicant: UTI Limited Partnership, Calgary (CA)

(72) Inventors: Nicholas ELDERFIELD, Calgary (CA); Joanna WONG, Calgary (CA)

(21) Appl. No.: 18/256,434

(22) PCT Filed: Dec. 7, 2021
(86) PCT No.: PCT/CA2021/051747

§ 371 Date: Jun. 8, 2023

Related U.S. Application Data
(60) Provisional application No. 63/122,971, filed on Dec. 9, 2020.

(51) Int. Cl. B29C 64/194; B29C 64/118; B29C 64/30; B33Y 10/00; B33Y 40/00; B33Y 70/10; B29C 64/393; B33Y 50/02

(52) U.S. Cl. CPC B29C 64/194; B29C 64/118; B29C 64/30; B33Y 10/00; B33Y 40/00; B33Y 70/10; B29C 64/393; B33Y 50/02; B29K 2101/12

(57) ABSTRACT

A method is provided for producing a fiber-reinforced composite in a fused filament fabrication (FFF) process for additive manufacturing, including: depositing, using a deposition tool, a composite raster by extruding the fiber-reinforced composite onto a deposition surface; miming a consolidation tool having a heated or heat-inducing non-rolling tip over the deposited composite raster, to apply a shear force to reduce fiber waviness; and applying, using the consolidation tool, heat and a compressive force concurrent with the application of the shear force to pressurize the composite raster and reduce void content. The process reduces porosity while at the same time, increasing fiber straightness in composite material deposited via FFF, increasing reinforcement-matrix adhesion, and matrix cohesion. A separate, independently controlled tool runs over previously deposited material using an interior point-out technique. The method reduces void contents of high fiber volume composites to a level suitable for the production of structural composite parts for aerospace applications, without requiring post-consolidation operations.

### FIELD

The present disclosure relates generally to additive manufacturing, and in particular to additive manufacturing using fiber-reinforced thermoplastic composites.

### BACKGROUND

Fiber reinforced composites are seeing increased usage for previously metallic structural components due to their higher strength and stiffness-to-weight ratios, dimensional stability, and corrosion resistance. An obstacle for their widespread adoption is the low level of automation in manufacturing them, as most composite production is still heavily reliant on manual operations where part quality is dependent on the skill of manufacturing technicians. Current automation approaches are too expensive for lower value products with low series.

Fiber reinforcements have become commonly used in additive manufacturing, also referred to as 3D printing, with the introduction of thermoplastic feedstock materials containing chopped fibers. While these chopped fibre reinforcements strengthen and stiffen additively manufactured materials to an extent, chopped fibres do not offer the mechanical properties of continuous fibre reinforcements required in many structural applications. Current additive manufacturing processes for continuous fiber reinforcement include small scale automated fiber placement (AFP) based systems using a roller, and fused filament fabrication (FFF) based systems. FFF-based systems, while being free of the restrictions and constraints associated with using a roller, are challenged to produce low void content composite parts; some approaches use post-consolidation operations, but this increases labor and tooling costs.

Improvements in approaches to additive manufacturing for fiber-reinforced composites are desirable.

### SUMMARY

As described and illustrated herein, a method is provided for producing a fiber-reinforced composite in a fused filament fabrication process for additive manufacturing, including, in an embodiment: depositing, using a deposition tool, a composite raster by extruding the fiber-reinforced composite onto a deposition surface; running a consolidation tool having a tip over the deposited composite raster, to apply a shear force to reduce fiber waviness; and applying, using the consolidation tool, heat and a compressive force concurrent with the application of the shear force to pressurize the composite raster and reduce void content.

In an example embodiment, the consolidation tool comprises a heated tip, and wherein the method comprises running the consolidation tool having the heated tip over the deposited composite raster, to apply heat and the shear force.

In an example embodiment, the consolidation tool comprises an ultrasonically vibrated non-rolling tip, and wherein the method comprises running the consolidation tool having the ultrasonically vibrated non-rolling tip over the deposited composite raster, to apply vibration and the shear force.

In an example embodiment, the consolidation tool comprises a heat-inducing non-rolling tip, and wherein the method comprises running the consolidation tool having the heat-inducing non-rolling tip over the deposited composite raster, to induce heat and apply the shear force.

In an example embodiment, the fiber-reinforced composite comprises a fiber-reinforcement and a thermoplastic matrix or intermediate materials for creating said composites.

In an example embodiment, the consolidation tool comprises an independently controlled heated tool, with the independent control being with respect to the deposition tool.

In an example embodiment, the consolidation tool comprises an independently controlled heat-inducing tool, with the independent control being with respect to the deposition tool.

In an example embodiment, the consolidation tool comprises an independently controlled ultrasonically vibrated tool, with the independent control being with respect to the deposition tool.

In an example embodiment, the deposited composite raster defines a raster length between a first end and a second end; and running the consolidation tool over the deposited composite raster comprises: starting from an intermediate point of the raster length and following a path of the raster towards each of the first end and the second end.

In an example embodiment, running the consolidation tool over the deposited composite raster comprises: starting from a midpoint of the raster length and following the path of the raster towards each of the first end and the second end.

In an example embodiment, running the consolidation tool over the deposited composite raster comprises: starting from the midpoint of the raster length and following the path of the raster to each of the first end and the second end.

In an example embodiment, running the consolidation tool over the deposited composite raster comprises: performing a first pass in a first direction; and performing a second pass in a second direction.

In an example embodiment, running the consolidation tool over the deposited composite raster to apply the shear force, comprises: dragging the tip over the deposited composite raster or set of adjacent rasters so as to develop tension in the fibers and pull the fibers straight in a direction of travel of the consolidation tool.

In an example embodiment, applying heat and the compressive force comprises fully wetting-out fibers in the fiber-reinforced composite.

In an example embodiment, applying heat and the compressive force to pressurize the composite raster and reduce void content comprises consolidation or filling out gaps within the composite raster.

In an example embodiment, applying heat and the compressive force to pressurize the composite raster and reduce void content comprises filling out gaps between the composite raster and surfaces surrounding the composite raster.

In an example embodiment, the consolidation tool comprises a controllable force actuator such as a pneumatic cylinder; and the compressive force is applied using the force actuator.

In an example embodiment, the consolidation tool comprises a heated tip and a heating element configured to heat the heated tip.

In an example embodiment, depositing the composite raster comprises: depositing a first composite raster, and depositing a second composite raster; and running the consolidation tool over the deposited composite raster comprises: running the consolidation tool over the first composite raster before the second composite raster is deposited.

In an example embodiment, depositing the composite raster comprises: depositing a first composite raster, and depositing a second composite raster; and running the consolidation tool over the deposited composite raster comprises: running the consolidation tool over the first composite raster after the first and second composite rasters are deposited.

In an example embodiment, depositing the composite raster comprises: depositing a first composite raster on a first deposition surface, and depositing a second composite raster on a second deposition surface; and running the consolidation tool over the deposited composite raster comprises: running the consolidation tool over the first composite raster on the first deposition surface concurrent with at least some of the second composite raster being deposited on the second deposition surface.

In an example embodiment, the fiber-reinforced composite comprises a continuous fiber composite.

In an example embodiment, the fiber-reinforced composite comprises fiber lengths greater than a contact length of a tip of the consolidation tool.

In an example embodiment, the fiber-reinforced composite comprises a matrix embedded with discontinuous fiber, or particulate materials.

In an example embodiment, the method further comprises: varying a velocity of the consolidation tool to produce a desired level of crystallinity in a thermoplastic matrix.

In an example embodiment, the method further comprises: varying a temperature of the consolidation tool to produce a desired level of crystallinity in a thermoplastic matrix.

In an example embodiment, a system has been devised wherein upon having deposited an initial length of a raster, a feed roller is retracted in order to allow the material deposition to be driven purely through tension developed by the motion of the deposition head.

In an example embodiment, the method uses nozzle force control rather than nozzle height control to improve the consistency and reliability of the deposition process.

In an example embodiment, the method and system impart a constant force via the nozzle and allow for free axial movement of the nozzle with variations in the deposition surface

In an example embodiment, the method comprises mounting the deposition tool and/or the consolidation tool on a controllable force actuator such as a pneumatic cylinder, spring, solenoid, or hydraulic cylinder.

In an example embodiment, the method comprises use of surface treatment laser etching/ablation on the deposition nozzle to modify interfacial energies.

### BRIEF DESCRIPTION OF THE DRAWINGS

Embodiments of the present disclosure will now be described, by way of example only, with reference to the attached Figures.

FIG. 1 illustrates aspects of a known automated fiber placement based additive manufacturing system.

FIG. 2 is a flowchart illustrating a method of producing a fiber-reinforced composite in a fused filament fabrication process for additive manufacturing according to an embodiment of the present disclosure.

FIG. 3 illustrates a fiber straightening process using a consolidation tool according to an embodiment of the present disclosure.

FIG. 4 shows optical microscope images of part cross sections without and with a consolidation operation according to an embodiment of the present disclosure.

FIG. 5 illustrates components of a consolidation tool according to an embodiment of the present disclosure.

FIG. 6 illustrates an example of sample B before and after strength testing.

FIG. 7 illustrates a CAD geometry of a mandrel, and a preview of a lattice structure produced according to an embodiment of the present disclosure.

FIG. 8 illustrates mold pieces used to cast a plaster mandrel around an aluminum core according to an example implementation.

FIG. 9 illustrates a first layer being deposited on the plaster mandrel according to the example implementation.

FIG. 10 illustrates a final compound curvature lattice structure produced according to the example implementation.

FIG. 11 illustrates a cylindrical lattice structure undergoing a consolidation and straightening process according to an embodiment of the present disclosure.

FIG. 12 illustrates a cylindrical auxetic structure being manufactured, featuring steered fibers to influence regional stiffnesses, according to an embodiment of the present disclosure.

FIG. 13 illustrates printed components produced according to an embodiment of the present disclosure after having undergone abrasive blasting with fine ground walnut shell media.

FIG. 14 illustrates examples of lattice structures according to an embodiment of the present disclosure which have been abrasive blasted.

### DETAILED DESCRIPTION

A method is provided for producing a fiber-reinforced composite in a fused filament fabrication process for additive manufacturing, including: depositing, using a deposition tool, a composite raster by extruding the fiber-reinforced composite onto a deposition surface; running a consolidation tool having a heated and/or ultrasonically vibrated non-rolling tip over the deposited composite raster, to apply a shear force to reduce fiber waviness; and applying, using the consolidation tool, heat and/or ultrasonic vibrations and a compressive force concurrent with the application of the shear force to pressurize the composite raster, reduce void content and increase adhesive bond strength. The process reduces porosity and increases bond strength while at the same time, increasing fiber straightness in composite material deposited via FFF. A separate, independently controlled tool runs over previously deposited material using an interior point-out technique. The method reduces void contents of high fiber volume composites to a level suitable for the production of structural composite parts for aerospace applications, without requiring post-processing operations.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

At the outset, for ease of reference, certain terms used in this application and their meaning as used in this context are set forth below. To the extent a term used herein is not defined below, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

“Aerospace-grade composite” represents a continuous fiber-reinforced composite material with a void content less than 1% or 2% and a fiber volume content greater than 40%.

“Consolidation process” represents a process in which composite material is placed under pressure and often elevated temperature to increase fiber wet-out, reduce porosity, and increase internal bond strength.

“Continuous fiber-reinforced composite” represent a composite material reinforced with fibers that have lengths significantly larger than their diameters. These fibers are not necessarily “continuous” as the term might imply.

“Deposition surface” represents any surface such as a bed, mandrel, or previously deposited material onto which new material will be deposited.

“Fiber” represents any reinforcing fiber such as carbon fiber, Kevlar, fiberglass, basalt, Innegra, flax, jute, Dyneema, or any fibrous transmission material such as metallic wire or fiber optic cable.

“Fiber volume content” represents the fraction of fiber volume to total material volume (including void regions) in a composite material, typically expressed as a percentage.

“Fiber wet-out” represents the degree to which the matrix material coats the individual fibers within a composite material.

“In-situ consolidation” represents a consolidation process which takes place during the material deposition stage.

“Matrix material” represents the binding material in a composite which holds the fibers together.

“Post-consolidation” represents a consolidation process which takes place after all material has been deposited. This process often involves moving a part produced using the deposited material into a different device such as an autoclave or heated press.

“Raster” represents a continuous length of material deposited in one pass. Common synonyms in the additive manufacturing field include “road” and “bead”.

“Straightening” represents the reduction or elimination of undesired waviness from fibers.

“Void content” represents the porosity of a material given in terms of the fraction of void volume to total material volume (including void regions), typically expressed as a percentage.

Embodiments of the present disclosure provide a novel process for increasing the quality of additively manufactured fiber-reinforced thermoplastic composites. In some embodiments, this process substantially reduces porosity and increases internal bond strength while at the same time, increasing fiber straightness in composite material deposited via fused filament fabrication (FFF).

Current methods of producing composite parts via FFF result in high void contents as the ability to fully consolidate the material during deposition is at odds with preventing material jamming from occurring within the deposition tool. A method according to an embodiment of the present disclosure uses a separate, independently controlled tool to run over previously deposited material using a midpoint-out technique. In an example embodiment, utilizing the adhesive hold of the deposited material, the tip of this tool imparts tension in the fibers as it is dragged along their paths, orienting them in the direction of its travel. At the same time, in an embodiment, heat and/or ultrasonic vibrations and pressure from this tip drives the matrix material to fully wet-out the fibers and close void regions.

Example embodiments of the present disclosure have been shown to reduce void contents of high fiber volume composites to below 1%, a critical achievement for the production of structural composite parts for aerospace applications. Additionally, short beam strength testing has confirmed that industry leading mechanical properties may be achieved using a method according to an embodiment of the present disclosure. Typically to produce such composite parts, post-processing operations such as vacuum bagging or compression molding are required according to known approaches, which result in increased labor and tooling costs. Such post-processing steps are not required according to embodiments of the present disclosure.

Fiber reinforced composites are seeing increased usage for previously metallic structural components due to their higher strength and stiffness-to-weight ratios, dimensional stability, and corrosion resistance. The main obstacle for their widespread adoption is the high processing cost. Most composite production is still heavily reliant on manual operations where part quality is dependent on the skill of manufacturing technicians. The aerospace industry has made great strides in automating the fabrication of large scale composite structures such as aircraft fuselages and wings; however, the development of such processes for the creation of smaller scale components is still underway.

Common usage of fiber reinforcements in additive manufacturing came with the introduction of thermoplastic feedstock materials containing chopped fibers. These small length fibers provide a significant increase to the material's stiffness along with a smaller increase in strength. Despite these improvements, components made with these materials still do not have the properties required for structural situations as the fibers are below the critical length necessary to exploit their full load bearing capacities. This deficiency has resulted in the development of additive manufacturing processes for continuous fiber-reinforced composites. Current additive manufacturing processes for these materials can be loosely grouped into two main categories: small scale automated fiber placement (AFP) based systems and fused filament fabrication (FFF) based systems.

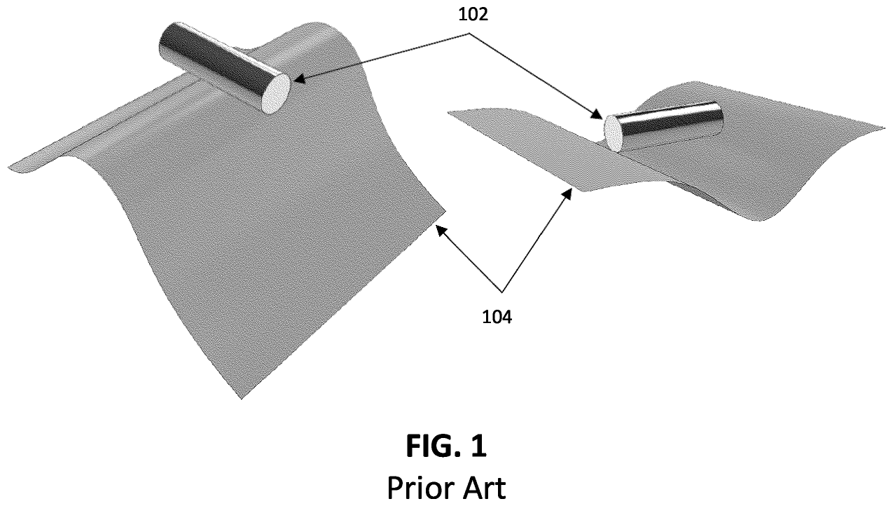

FIG. 1 illustrates aspects of a known automated fiber placement based additive manufacturing system. Small scale AFP systems are based on a more mature technology which utilizes fiber-reinforced tapes/towpregs impregnated with a matrix material (either thermoplastic or thermoset). The tapes are deposited via a roller 102 with a thermoplastic melting system (e.g. laser or heated gas stream) or thermoset curing system (e.g. UV light, laser, or heated gas stream) directed at the intersection between the tape being deposited and the underlying surface. These types of systems can produce very high quality, aerospace-grade composite parts without the need for any post-consolidation operations as the roller compacts the material as it is deposited. Despite this, the use of a roller to compact the material leads to some limitations in geometries that can be manufactured.

As the contact patch of the roller is linear, compaction on deposition surfaces 104, which are shown in FIG. 1 as curved surfaces, leads to pressure variations over the roller's width which in turn, results in varying levels of material consolidation. This puts practical limitations on the minimum surface curvatures that these systems can handle (see FIG. 1). Additionally, the use of tapes puts limitations on the minimum turn radii that can be achieved as the tape will wrinkle or even fold if turned too sharply, resulting in fiber buckling and void regions. FIG. 1 also illustrates surface curvature limitations for AFP systems on convex surfaces (left) and concave surfaces (right). Note the minimal contact regions between the roller 102 and the deposition surface 104 in each situation.

The use of FFF systems to deposit continuous fibers is relatively new. These systems extrude a thermoplastic matrix material along with the reinforcing fibers through a heated nozzle to build up a part in layers. FFF-based systems have the distinct advantage of a narrow, omnidirectional deposition tool (i.e. the nozzle). Unlike AFP systems where a roller must always be trailing behind the deposition travel direction, the round orifice of the nozzle requires no rotation to change directions. This results in much lower device and toolpath planning complexity as fewer motion actuation systems are necessary. Additionally, minimum turn radii become much smaller as the deposited material is not in the form of a tape and is therefore much less prone to wrinkling. Furthermore, without the encumbrance of a roller, surface curvature limitations become much less restrictive allowing for material deposition over higher complexity geometries.

Despite these excellent advantages, FFF-based systems are currently hindered by an inability to produce low void content composite parts without post-consolidation operations. The only in-situ consolidation operation that FFF based processes make use of is the use of the nozzle's bottom surface to press down the material as it is deposited. An issue with this single step process of deposition and consolidation with the nozzle lies in the high likelihood of filament jamming occurring within the extrusion channel if the nozzle is too close to the deposition surface. As such, it appears that companies accept the compromise of having higher void contents for the sake of simplicity and reliability.

Another important characteristic of continuous fiber composites is fiber straightness. To maximize component strength and stiffness, fibers need to be well oriented along their specified paths with little waviness. Any deviations from these paths allows for greater deflection to occur under load before the fibers start to provide the desired resistance. Additionally, non-aligned fibers introduce more complicated stress states in the material, lowering overall strength. This is a well known problem in the composites industry and is the reason for the development of non-crimp fabrics. These fabrics are not woven together but rather stitched together, as weaving introduces a waviness to the fibers.

AFP systems generally rely on tension to drive the deposition of the composite tapes and thereby naturally impart a high degree of straightness to the fibers. FFF systems on the other hand are an extrusion technology which does not rely on tension to drive deposition. Due to this, fibers can develop a waviness during deposition if the material feed rate is not exactly matched with the deposition head's movement rate. Additionally, keeping the material under tension during deposition may impede the ability to steer fibers through tight turn radii as the material may break free from the underlying surface if the tension exceeds the adhesive strength.

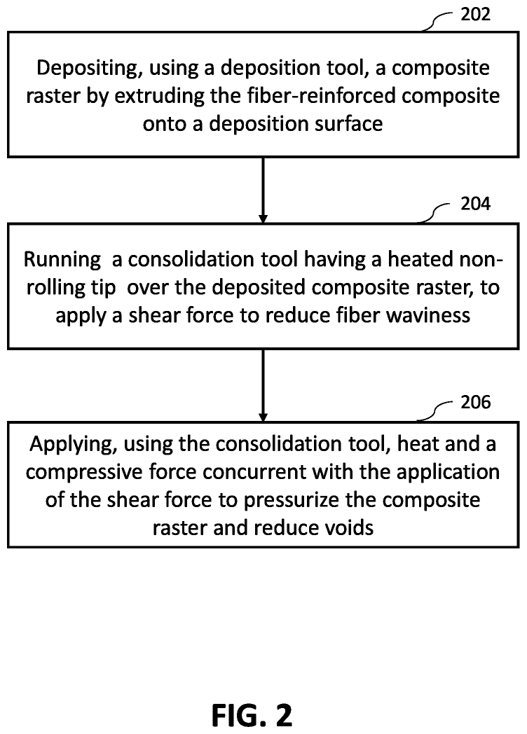

FIG. 2 is a flowchart illustrating a method of producing a fiber-reinforced composite in a fused filament fabrication process for additive manufacturing according to an embodiment of the present disclosure. As shown in FIG. 2, in an embodiment the method includes, at 202, depositing, using a deposition tool, a composite raster by extruding the fiber-reinforced composite onto a deposition surface. In the embodiment of FIG. 2, the method also includes, at 204, running a consolidation tool having a heated and/or ultrasonically vibrated non-rolling tip over the deposited composite raster, to apply a shear force to reduce fiber waviness.

In an example embodiment, the tip is a fixed structure that is not rolling, in contrast to known approaches. In an embodiment, the tip is a smooth tip. In an alternate embodiment, the tip is a rough tip. In an example embodiment, the tip is wider than the raster. In an example embodiment, the length of fiber should be a little longer than the length of the tip. In an example embodiment, running the consolidation tool over the deposited composite raster comprises sliding or dragging the tool over the deposited composite raster.

In the embodiment of FIG. 2, the method further comprises, at 206, applying, using the consolidation tool, heat and/or ultrasonic vibrations and a compressive force concurrent with the application of the shear force to pressurize the composite raster and decrease void content. In an embodiment the void content comprises intra-raster voids, which are within the deposited composite raster. In an embodiment, the void content comprises inter-raster voids, which are between deposited composite rasters.

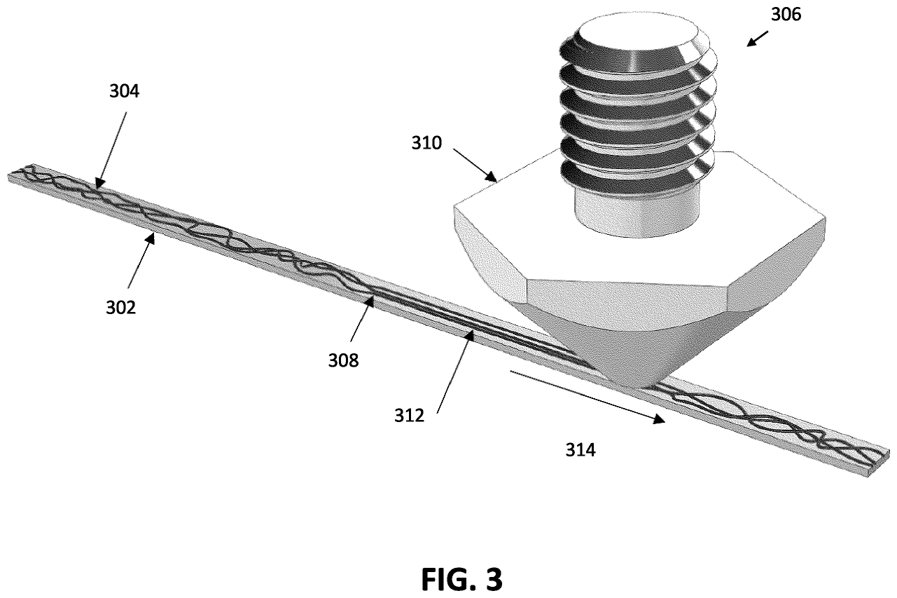

FIG. 3 illustrates a fiber straightening process using a consolidation tool according to an embodiment of the present disclosure. The embodiments described and illustrated in relation to FIG. 2 and FIG. 3 comprise a new, in-situ process for increasing the quality of fiber-reinforced composite parts manufactured via the FFF technique. Embodiments according to this process may enhance material properties in one, two, three or all of these manners: increasing fiber straightness, decreasing void content, increasing internal bond strength and modifying the degree of crystallinity in the polymer matrix.

In an embodiment, the method occurs in two stages. In the first stage, a composite raster 302 is deposited, for example via a conventional FFF process wherein a fiber-reinforcement and a thermoplastic matrix are extruded onto a deposition surface. An example of the individual fibers as deposited is shown at 304. In the second stage, a consolidation tool 306, which may be an independently controlled heated and/or ultrasonically vibrated tool, is run over the deposited raster, for example starting from a midpoint 308 and following its path out to each end, which may requires two passes, one in each direction. In an embodiment, the consolidation tool is heated to above softening temperature to enable consolidation and promote adhesion. In an example embodiment, by dragging the tool's heated and/or ultrasonically vibrated tip 310 from a midpoint-out, tension is developed in the fibers, pulling them straight, as shown at 312, in the direction of the tool's travel direction 314. This ensures that as short as possible fiber length is used over the rasters path, maximizing the mechanical performance of the material. At the same time, in an embodiment, a compressive force is applied by the tool to pressurize the heated and/or ultrasonically vibrated thermoplastic matrix, driving it to fully wet-out the fibers and fill in the gaps between the raster and the surfaces surrounding it.

In an example embodiment, the consolidation and straightening operation described herein occurs separately from the material deposition process. The independence of the consolidation tool allows for the midpoint-out pathing which results in fiber straightening. The consolidation and straightening operation may occur after each raster is deposited, or it may be delayed until an entire layer (a group of rasters) has been deposited. As the consolidation tool is independent from the deposition tool, the two processes could occur concurrently on separate rasters, with the deposition tool depositing one raster while the consolidation tool processes a different one. This is inherently different from the consolidation operation used in known approaches, where the material is consolidated as it is deposited by applying pressure with a surface on the deposition tool (typically the underside of the nozzle). As noted previously, a high degree of consolidation is not currently achievable via these known methods.

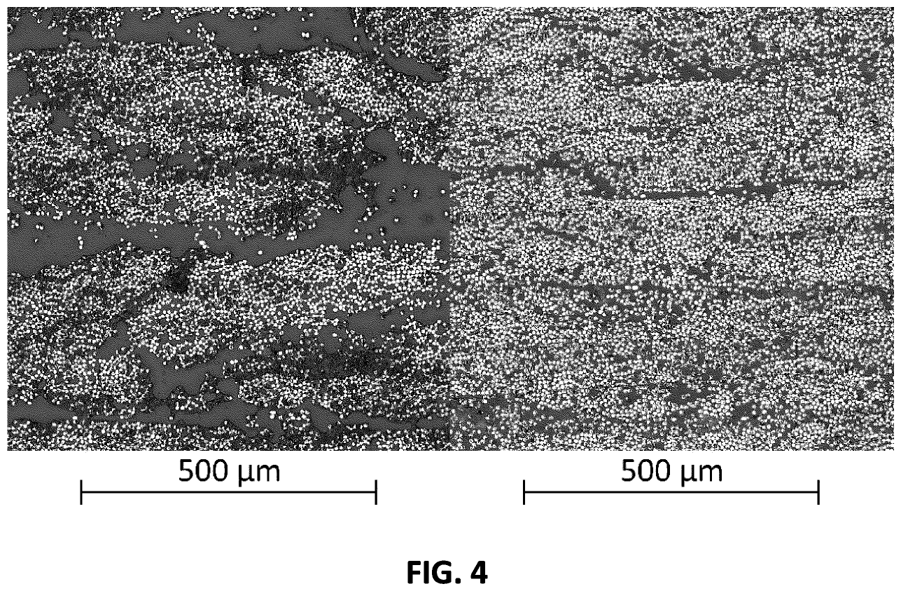

FIG. 4 shows optical microscope images of part cross sections without and with a consolidation operation according to an embodiment of the present disclosure. Through microscope analysis of sample cross sections, it has been verified that a method according to an embodiment of the present disclosure produces composites with void contents below 1%. The microscope images in FIG. 4 show part cross sections which have been manufactured without (left) and with (right) the consolidation process according to an embodiment of the present disclosure. The feedstock material used in this example implementation was a carbon fiber reinforced PA12 with a 50% fiber volume content. The void regions in these images have been shaded blue, matrix material is dark grey, and fibers are white. The non-consolidated sample shows a void content of 28% while the consolidated sample shows a void content of 0.2%.

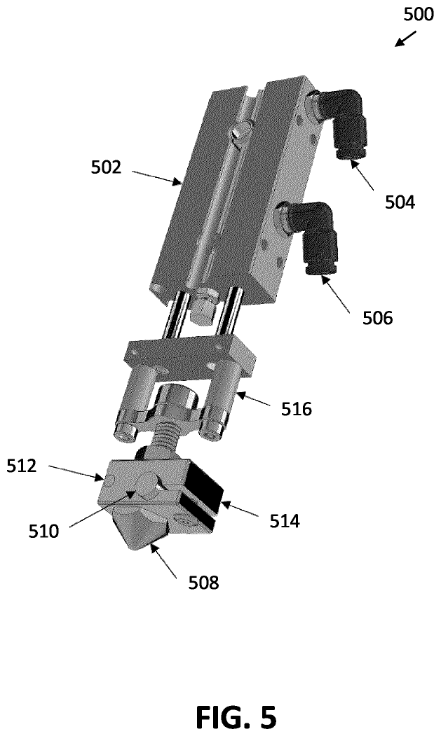

FIG. 5 illustrates components of a consolidation tool 500 according to an embodiment of the present disclosure. In an embodiment, the consolidation tool 500 is similar to the consolidation tool 306 of FIG. 3. To ensure consistent and precise consolidation pressure, a pneumatic cylinder 502 may be used to deliver the compaction force. As pneumatic cylinders provide the same force regardless of the piston's displacement at a set air pressure, height deviations in the deposited material will not result in consolidation pressure variations. The ability to regulate the air pressure sent to the pneumatic cylinder, for example via a piston extension air inlet 504 and/or a piston retraction air inlet 506, allows for complete control of the pressure applied to the material. This allows the tool to be calibrated for optimal processing windows required for different materials. Additionally, pressure can be varied at different points of a raster to increase the compressive force on intersection points, preventing the development of thickness increases at these points. In an alternative embodiment, the method comprises increasing the amount of consolidation time on intersection points to provide additional time for material to be reshaped by the applied pressure. A further benefit of utilizing a pneumatic cylinder is the ability to retract the tool when it is not in use, providing clearance for other tools to operate. Other mechanisms may be utilized to generate the compaction force such as springs, solenoids, or hydraulics.

A consolidation tool tip 508 according to an embodiment of the present disclosure, which may be similar to the consolidation tool tip 310 of FIG. 3, has a known contact area so that pressure applied to the material can be determined, for example compaction force divided by contact area. In an example embodiment, this tip 508 has rounded edges so that fibers are not abraded by sharp features. The surface of this tip 508 may also utilize friction reduction features such as hydrophobic laser etching or a tungsten disulfide coating to further reduce abrasion. In an example embodiment, the tip 508 is made of a heat conductive and abrasion resistant material such as hardened steel or stainless steel. Plating may be used to further improve the abrasion resistance or thermal conductivity.

The consolidation tool tip 508 may be heated through the use of an electrical resistance heating element 510. A temperature sensor 512 such as a thermistor, thermocouple, or RTD sensor may be used to monitor the temperature. A feedback loop may control the temperature by varying the current through the heating element 510 based on the temperature sensors reading. The heat may be conducted to the tip 508 using a heater block 514. Thermal insulators 516, such as ceramic insulators, may be used to prevent conduction of heat into temperature sensitive components above the consolidation tool tip region.

According to embodiments of the present disclosure, benefits of the straightening and consolidation operation are not limited to continuous fiber composites. In example implementations, the straightening characteristics will occur as long as the fiber lengths are greater than the consolidation tool tip's contact length as there will be a portion of the fiber held by adhesive bond to maintain tension. In example implementations, the consolidation aspect applies regardless of fiber length and is not even restricted to composites with fiber reinforcements. A matrix embedded with particulate materials would also likely see porosity reductions and improved adhesion and cohesion strengths using this process.

A further benefit of the consolidation tool's independence according to an example embodiment is that the velocity and temperature of the consolidation tool can be varied to provide idealized temperature profiles for the production of a desired level of crystallinity in a thermoplastic matrix. If a slower cooling rate is desirable to promote higher crystallization, in an embodiment the tool velocity is slowed down. Likewise, if an amorphous matrix structure is desired, in an embodiment the velocity is increased. The tool's temperature can be varied so that the matrix is brought past its melting point, or only above its glass transition point. Temperature ramping can also be utilized to further manipulate effects.

The consolidation tool may also use different means to heat or consolidate material such as the use of ultrasonic vibrations. The consolidation tip may be mounted to an ultrasonic welding tool, acting as the welding horn. In another embodiment, dielectric heating (microwave/radio wave) or induction heating are used to heat the material rather than using an electrical resistance element. These methods allow for deeper heat penetration in a smaller period of time, potentially increasing the speed of the consolidation process. Additionally, a gas may be flowed over the consolidation region during the consolidation process to prevent oxidation or to incur a chemical reaction with the material.

The overall system described herein may be fully enclosed within a chamber to ensure consistent environmental temperature or gas composition, and to prevent contamination. In an embodiment, the chamber is sealed and evacuated to produce a low pressure or vacuum environment which would reduce the likelihood of void formation during material deposition.

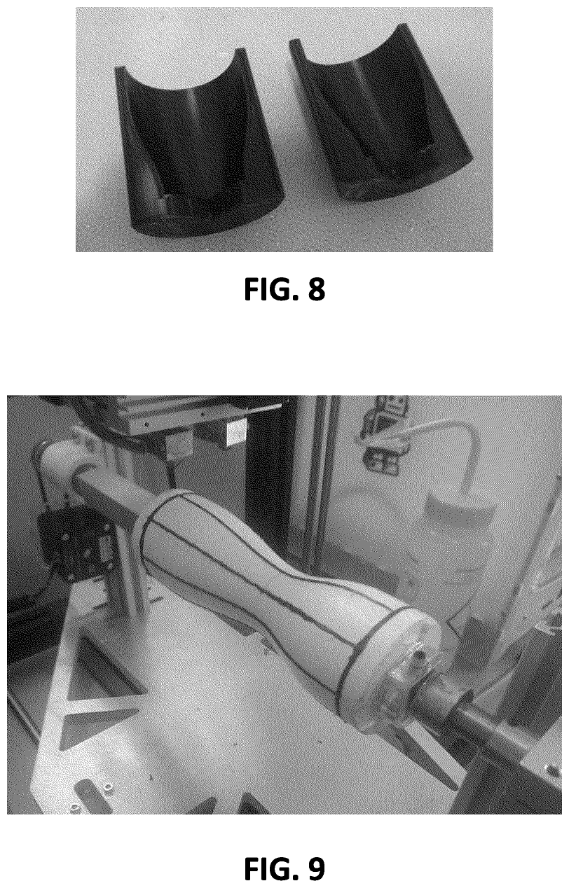

In another aspect, the present disclosure provides an improvement upon the extrusion driver system for continuous fiber feedstocks in an FFF device. FIG. 8 illustrates a fused filament fabrication deposition head and associated retraction of a feed roller according to an embodiment of the present disclosure.

In current systems, the material extrusion rate must be exactly matched to the deposition head movement rate to prevent under or over extrusion of the material. If under extruded, tension develops in the system potentially leading to fiber breakage or adhesive failure of the raster. If over extruded, wrinkling occurs in the fibers and jamming may occur within the extrusion channel. To circumvent this, embodiments of the present disclosure provide a system wherein upon having deposited an initial length of a raster, a feed roller is retracted in order to allow the material deposition to be driven purely through tension developed by the motion of the deposition head. See FIG. 8, which is a schematic diagram of an FFF deposition head according to an embodiment of the present disclosure showing how a feed roller may be retracted for tension driving.

Additionally, in an example embodiment, using nozzle force control rather than nozzle height control may greatly improve the consistency and reliability of the deposition process. Current systems set a nozzle height relative to the deposition surface and extrude the material from that height; however, this can lead to tolerance stack up issues as the number of layers increases. These errors lead to a varying deposition heights which in turn result in a varying deposition forces/pressures. Rather than trying to achieve a precise height, embodiments of the present disclosure impart a constant force via the nozzle and allow for free vertical movement of the nozzle with variations in the deposition surface. This ensures that the important processing parameters are kept constant (i.e. deposition pressure) rather than allowing such parameters to vary. This may be achieved by mounting the deposition tool on a controllable force actuator such as a pneumatic cylinder, spring, solenoid, or hydraulic cylinder.

A further improvement to the FFF deposition process according to an embodiment of the present disclosure comprises the use of hydrophobic laser etching/ablation on the deposition nozzle. This example embodiment helps to minimize its friction with the material being deposited, potentially allowing for higher pressures to be applied by the nozzle during deposition. This may reduce the porosity that needs to be eliminated by the subsequent consolidation and fiber straightening operation.

### EXPERIMENT DETAILS

The details below are provided for one example experiment conducted in relation to an example embodiment of the present disclosure.

Material

The filament used to manufacture the test specimens is a carbon fiber-reinforced PA12″. This material has a fiber volume content of 50%. nominal specimen dimensions are shown in Table 1. All five specimens were printed in a continuous strip and then cut and sanded to final dimensions.

TABLE 1
Nominal test specimen dimensions

| | |
|---|---|
| Thickness (mm) | 2 |
| Width (mm) | 4 |
| Length (mm) | 12 |

Moisture levels have a significant impact on the mechanical properties of polymers and as such, environmental conditioning of test specimens is desirable to ensure repeatable results. For this study, specimens were dried in a vacuum oven at 40° C. for approximately 48 hours prior to testing to reduce the moisture content to a negligible level.

Procedure

A Tinius Olsen H25KS load frame with a Tinius Olsen FBB-1kN load cell was used to perform the tests. As per the ASTM D2344 standard, two 0.125″ steel dowels were used as supports and a 0.25″ steel dowel was used as the loading nose. The span between the supports for this test was 8mm. Two 3D printed jigs were used to precisely position the dowels at the beginning of each test. The cross head was then moved down until it placed approximately 20 N of force on the setup, holding the dowels in place via friction and allowing the jigs to be removed. The cross head was then displaced at a rate of 1 mm/min until the loading on the specimen began to notably drop off. The maximum load experienced by each sample during the tests was recorded and used to calculate the corresponding short-beam strengths using the following equation:

$$Short Beam Strength ( MPa ) = 0.75 \times \frac{Maximum Load ( N )}{Width ( mm ) \times Thickness ( mm )}$$

Results

The results from the tests are summarized in Table 2 below.

TABLE 2
Results of short-beam strength testing.

| | | | | | Short-Beam |
|---|---|---|---|---|---|
| | Thickness | Width | Length | Maximum | Strength |
| Specimen | (mm) | (mm) | (mm) | Load (N) | (MPa) |
| A | 1.97 | 3.91 | 12.06 | 646.93 | 63.0 |
| B | 1.96 | 3.98 | 12.05 | 624.57 | 60.0 |
| C | 1.96 | 3.90 | 12.01 | 568.30 | 55.8 |
| D | 1.97 | 3.87 | 12.01 | 557.37 | 54.8 |
| E | 1.90 | 4.01 | 11.98 | 538.27 | 53.0 |
| | | | | Average (MPa) | 57.3 |
| | | | | Standard Deviation | 4.1 |
| | | | | (MPa) | |

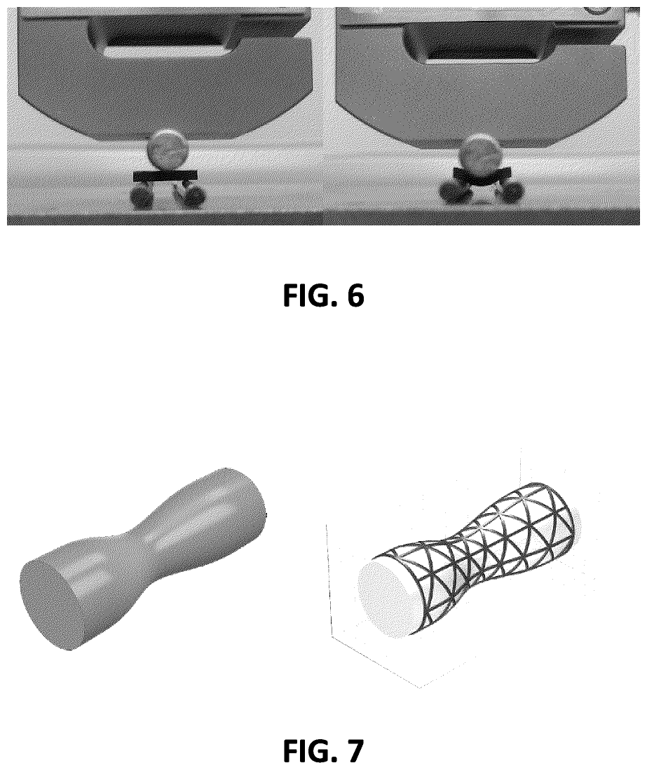

FIG. 6 illustrates an example of sample B before and after strength testing, namely photos of a sample before and after testing. The mode of failure exhibited by every specimen was interlaminar shear.

### Process Examples

Some examples of parts manufactured with the straightening and consolidation operation according to an embodiment of the present disclosure will now be illustrated and described. As a process according to an embodiment of the present disclosure results in highly oriented fibers, it is especially beneficial for the creation of lattice structures where the efficiency of material usage is paramount. These structures have exceptionally high strength and stiffness-to-weight ratios and are difficult to fabricate using conventional composite manufacturing techniques.

Compound Curvature Lattice Structure

FIG. 7 illustrates a CAD geometry of a mandrel, and a preview of a lattice structure produced according to an embodiment of the present disclosure. To fully take advantage of the properties of continuous fiber composites, orienting the fibers along three-dimensional paths is often necessary. To make this possible, an additional rotational axis may be installed on an FFF device so that a mandrel may be used as the deposition surface. This mandrel defines the internal geometry of the part to be manufactured. To make the compound curvature lattice structure, CAD geometry of the mandrel is first created (see FIG. 7, left). The CAD geometry may then be imported into a custom toolpathing software. This software allows the user to input desired fiber placements and angles to create the desired geometry and then export the toolpaths in a g-code format (see FIG. 7, right).

The mandrel may be fabricated in any plurality of ways such as machining, casting, or additive manufacturing. When casting, it is important to use a material that exhibits negligible or predictable shrinkage during setting so as to produce a dimensionally accurate mandrel. Additionally, the mandrel may be a pre-existing part to receive additional reinforcement or features. In this example, a conventional FFF 3D printer was used to print molds for casting a plaster mandrel. FIG. 8 illustrates mold pieces used to cast a plaster mandrel around an aluminum core according to an example implementation. These molds do not need to use a substantial amount of material as they do not see any large forces, allowing the user to utilize fast manufacturing settings. Plaster is then cast in these molds with a square aluminum core at the center. This core is used to mount the mandrel on the rotational axis and act as a torque transfer device.

For this example, the mandrel was then mounted on the rotational axis and a continuous carbon fiber-reinforced PA12 feedstock with 50% fiber volume content was deposited onto it via a conventional FFF process. FIG. 9 illustrates a first layer being deposited on the plaster mandrel according to the example implementation. After each layer was deposited, the consolidation and straightening operation was performed using the consolidation tool.

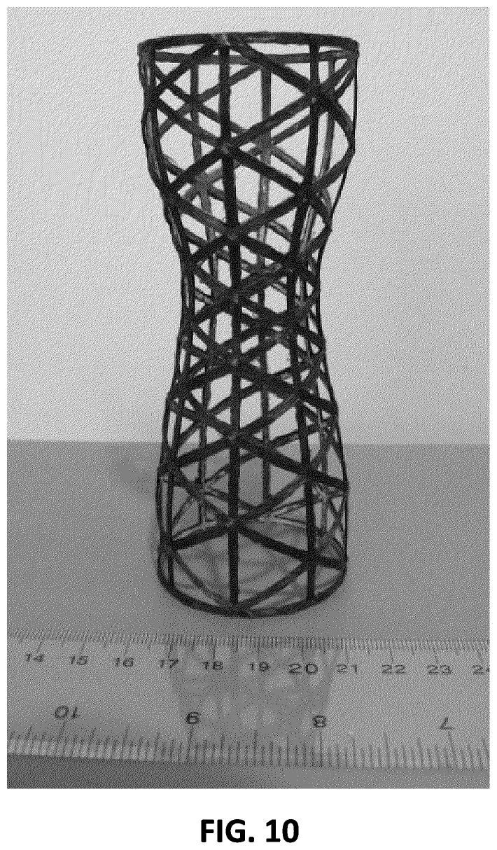

Once all material was deposited, consolidated, and straightened, the aluminum core was removed and the plaster mandrel was broken, releasing the finished part. FIG. 10 illustrates a final compound curvature lattice structure produced according to the example implementation. In this example, the mandrel was disintegrated with hand tools. In another embodiment, this process may be automated by using such methods as transmitting mechanical vibrations, torque, or pneumatic pressure through the core. In the case of plaster, the used material may be ground up, baked, and recast. Destruction of the mandrel may not always be necessary as it may be possible to release the part via positive draft angles, multipiece mandrels, or collapsible mandrels.

This example shows the flexibility of the consolidation tool and method according to an embodiment of the present disclosure to operate around complex geometries and to produce stiff lattice geometries with highly oriented fibers. Furthermore, no post-processing operations are required to achieve a low void content, aerospace-grade part. No other current automated form of composite manufacturing would be capable of producing this part.

Cylindrical Structures

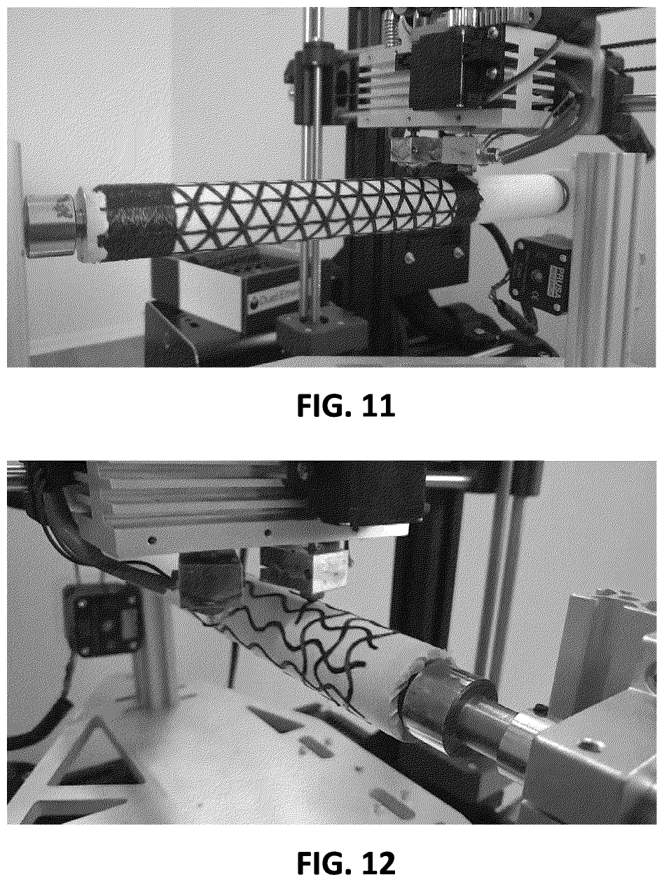

Manufacturing cylindrical structures is a simpler matter than the compound curvature geometry as the mandrel is a simple cylinder. A sleeve may be placed over this mandrel to act as a deposition surface that can be slid off once the manufactured part is ready to be released. FIGS. 11-13 illustrate various parts that have been manufactured with a consolidation and straightening operation or method according to an embodiment of the present disclosure, showing the wide variety of applications for this process.

FIG. 11 illustrates a cylindrical lattice structure undergoing a consolidation and straightening process according to an embodiment of the present disclosure. FIG. 12 illustrates a cylindrical auxetic structure being manufactured, featuring steered fibers to influence regional stiffnesses, according to an embodiment of the present disclosure.

Post Processing

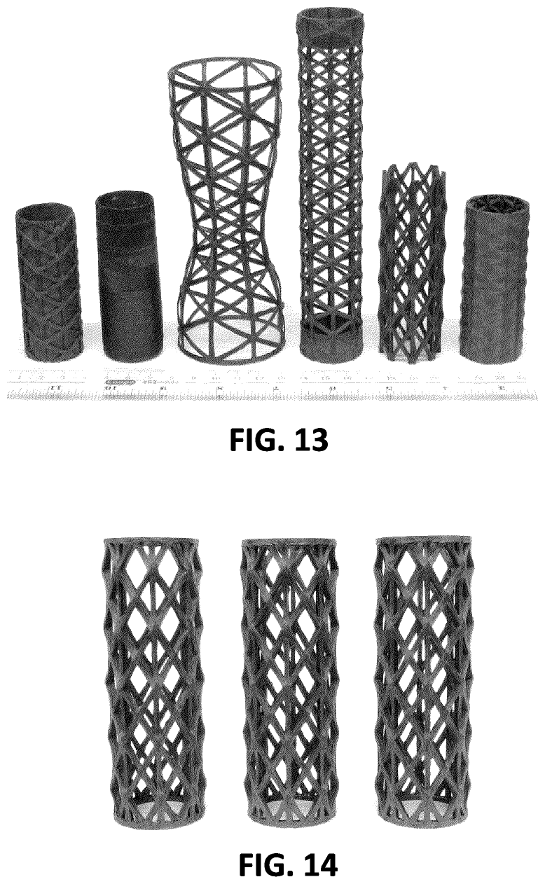

According to an example implementation, abrasive blasting provides an excellent means for cleaning up the surfaces of parts manufactured according to a process according to embodiments of the present disclosure. Ideal blasting media is fine and soft, and used at low air pressure (20 psi works well). Some examples of media that work well are ground walnut shell, ground corn cob, plastic pellets, and baking soda. FIGS. 13 and 14 show parts having undergone the abrasive blasting operation. FIG. 13 illustrates printed components produced according to an embodiment of the present disclosure after having undergone abrasive blasting with fine ground walnut shell media. FIG. 14 illustrates examples of lattice structures according to an embodiment of the present disclosure which have been abrasive blasted.

As described above and illustrated herein, the present disclosure provides a number of embodiments, including the following.

Embodiment 1: A method of producing a fiber-reinforced composite in a fused filament fabrication process for additive manufacturing, comprising: depositing, using a deposition tool, a composite raster by extruding the fiber-reinforced composite onto a deposition surface; running a consolidation tool having a tip over the deposited composite raster, to apply a shear force to reduce fiber waviness; and applying, using the consolidation tool, heat and a compressive force concurrent with the application of the shear force to pressurize the composite raster and reduce void content.

Embodiment 2: The method of embodiment 1 wherein the consolidation tool comprises a heated tip, and wherein the method comprises running the consolidation tool having the heated tip over the deposited composite raster, to apply heat and the shear force.

Embodiment 3: The method of embodiment 1 wherein the consolidation tool comprises an ultrasonically vibrated non-rolling tip, and wherein the method comprises running the consolidation tool having the ultrasonically vibrated non-rolling tip over the deposited composite raster, to apply vibration and the shear force.

Embodiment 4: The method of embodiment 1 wherein the consolidation tool comprises a heat-inducing non-rolling tip, and wherein the method comprises running the consolidation tool having the heat-inducing non-rolling tip over the deposited composite raster, to induce heat and apply the shear force.

Embodiment 5: The method of any one of embodiments 1 to 4 wherein the fiber-reinforced composite comprises a fiber-reinforcement and a thermoplastic matrix or intermediate materials for creating said composites.

Embodiment 6: The method of any one of embodiments 1 to 5 wherein the consolidation tool comprises an independently controlled heated tool, with the independent control being with respect to the deposition tool.

Embodiment 7: The method of any one of embodiments 1 to 5 wherein the consolidation tool comprises an independently controlled heat-inducing tool, with the independent control being with respect to the deposition tool.

Embodiment 8: The method of any one of embodiments 1 to 5 wherein the consolidation tool comprises an independently controlled ultrasonically vibrated tool, with the independent control being with respect to the deposition tool.

Embodiment 9: The method of any one of embodiments 1 to 8 wherein: the deposited composite raster defines a raster length between a first end and a second end; and running the consolidation tool over the deposited composite raster comprises: starting from an intermediate point of the raster length and following a path of the raster towards each of the first end and the second end.

Embodiment 10: The method of embodiment 9 wherein running the consolidation tool over the deposited composite raster comprises: starting from a midpoint of the raster length and following the path of the raster towards each of the first end and the second end.

Embodiment 11: The method of embodiment 10 wherein running the consolidation tool over the deposited composite raster comprises: starting from the midpoint of the raster length and following the path of the raster to each of the first end and the second end.

Embodiment 12: The method of any one of embodiments 1 to 11 wherein running the consolidation tool over the deposited composite raster comprises: performing a first pass in a first direction; and performing a second pass in a second direction.

Embodiment 13: The method of any one of embodiments 1 to 11 wherein running the consolidation tool over the deposited composite raster to apply the shear force, comprises: dragging the tip over the deposited composite raster or set of adjacent rasters so as to develop tension in the fibers and pull the fibers straight in a direction of travel of the consolidation tool.

Embodiment 14: The method of any one of embodiments 1 to 13 wherein applying heat and the compressive force comprises fully wetting-out fibers in the fiber-reinforced composite.

Embodiment 15: The method of any one of embodiments 1 to 13 wherein applying heat and the compressive force to pressurize the composite raster and reduce void content comprises consolidation or filling out gaps within the composite raster.

Embodiment 16: The method of any one of embodiments 1 to 13 wherein applying heat and the compressive force to pressurize the composite raster and reduce void content comprises filling out gaps between the composite raster and surfaces surrounding the composite raster.

Embodiment 17: The method of any one of embodiments 1 to 16 wherein: the consolidation tool comprises a controllable force actuator such as a pneumatic cylinder; and the compressive force is applied using the force actuator.

Embodiment 18: The method of any one of embodiments 1 to 16 wherein: the consolidation tool comprises a heated tip and a heating element configured to heat the heated tip.

Embodiment 19: The method of any one of embodiments 1 to 18 wherein depositing the composite raster comprises: depositing a first composite raster, depositing a second composite raster; and running the consolidation tool over the deposited composite raster comprises: running the consolidation tool over the first composite raster before the second composite raster is deposited.

Embodiment 20: The method of any one of embodiments 1 to 18 wherein depositing the composite raster comprises: depositing a first composite raster, and depositing a second composite raster; and running the consolidation tool over the deposited composite raster comprises: running the consolidation tool over the first composite raster after the first and second composite rasters are deposited.

Embodiment 21: The method of any one of embodiments 1 to 18 wherein depositing the composite raster comprises: depositing a first composite raster on a first deposition surface, and depositing a second composite raster on a second deposition surface; and running the consolidation tool over the deposited composite raster comprises: running the consolidation tool over the first composite raster on the first deposition surface concurrent with at least some of the second composite raster being deposited on the second deposition surface.

Embodiment 22: The method of any one of embodiments 1 to 21 wherein the fiber-reinforced composite comprises a continuous fiber composite.

Embodiment 23: The method of any one of embodiments 1 to 22 wherein the fiber-reinforced composite comprises fiber lengths greater than a contact length of a tip of the consolidation tool.

Embodiment 24: The method of any one of embodiments 1 to 23 wherein the fiber-reinforced composite comprises a matrix embedded with discontinuous fiber, or particulate materials.

Embodiment 25: The method of any one of embodiments 1 to 24 further comprising: varying a velocity of the consolidation tool to produce a desired level of crystallinity in a thermoplastic matrix.

Embodiment 26: The method of any one of embodiments 1 to 25 further comprising: varying a temperature of the consolidation tool to produce a desired level of crystallinity in a thermoplastic matrix.

Embodiment 27: A system according to which, upon having deposited an initial length of a raster, a feed roller is retracted in order to allow the material deposition to be driven purely through tension developed by the motion of the deposition head.

Embodiment 28: The method uses nozzle force control rather than nozzle height control to improve the consistency and reliability of the deposition process.

Embodiment 29: The method and system impart a constant force via the nozzle and allow for free axial movement of the nozzle with variations in the deposition surface

Embodiment 30: The method comprises mounting the deposition tool and/or the consolidation tool on a controllable force actuator such as a pneumatic cylinder, spring, solenoid, or hydraulic cylinder.

Embodiment 31: The method comprises use of surface treatment laser etching/ablation on the deposition nozzle to modify interfacial energies.

In the preceding description, for purposes of explanation, numerous details are set forth in order to provide a thorough understanding of the embodiments. However, it will be apparent to one skilled in the art that these specific details are not required. In other instances, well-known mechanical structures, electrical structures and circuits are shown in generalized or block diagram form in order not to obscure the understanding. For example, specific details are not provided as to whether the embodiments described herein are implemented as a software routine, hardware circuit, firmware, or a combination thereof.

Some aspects of embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A method of producing a fiber-reinforced composite in a fused filament fabrication process for additive manufacturing, comprising:
depositing, using a deposition tool, a composite raster by extruding the fiber-reinforced composite onto a deposition surface;
running a consolidation tool having a tip over the deposited composite raster, to apply a shear force to reduce fiber waviness; and
applying, using the consolidation tool, heat and a compressive force concurrent with the application of the shear force to pressurize the composite raster and reduce void content.

2. The method of claim 1 wherein the consolidation tool comprises a heated tip, and wherein the method comprises running the consolidation tool having the heated tip over the deposited composite raster, to apply heat and the shear force.

3. The method of claim 1 wherein the consolidation tool comprises an ultrasonically vibrated non-rolling tip, and wherein the method comprises running the consolidation tool having the ultrasonically vibrated non-rolling tip over the deposited composite raster, to apply vibration and the shear force.

4. The method of claim 1 wherein the consolidation tool comprises a heat-inducing non-rolling tip, and wherein the method comprises running the consolidation tool having the heat-inducing non-rolling tip over the deposited composite raster, to induce heat and apply the shear force.

5. The method of any one of claims 1 to 4 wherein the fiber-reinforced composite comprises a fiber-reinforcement and a thermoplastic matrix or intermediate materials for creating said composites.

6. The method of any one of claims 1 to 5 wherein the consolidation tool comprises an independently controlled heated tool, with the independent control being with respect to the deposition tool.

7. The method of any one of claims 1 to 5 wherein the consolidation tool comprises an independently controlled heat-inducing tool, with the independent control being with respect to the deposition tool.

8. The method of any one of claims 1 to 5 wherein the consolidation tool comprises an independently controlled ultrasonically vibrated tool, with the independent control being with respect to the deposition tool.

9. The method of any one of claims 1 to 8 wherein:
the deposited composite raster defines a raster length between a first end and a second end; and
running the consolidation tool over the deposited composite raster comprises:
starting from an intermediate point of the raster length and following a path of the raster towards each of the first end and the second end.

10. The method of claim 9 wherein running the consolidation tool over the deposited composite raster comprises:
starting from a midpoint of the raster length and following the path of the raster towards each of the first end and the second end.

11. The method of claim 10 wherein running the consolidation tool over the deposited composite raster comprises:
starting from the midpoint of the raster length and following the path of the raster to each of the first end and the second end.

12. The method of any one of claims 1 to 11 wherein running the consolidation tool over the deposited composite raster comprises:
performing a first pass in a first direction; and
performing a second pass in a second direction.

13. The method of any one of claims 1 to 11 wherein running the consolidation tool over the deposited composite raster to apply the shear force, comprises:
dragging the tip over the deposited composite raster or set of adjacent rasters so as to develop tension in the fibers and pull the fibers straight in a direction of travel of the consolidation tool.

14. The method of any one of claims 1 to 13 wherein applying heat and the compressive force comprises fully wetting-out fibers in the fiber-reinforced composite.

15. The method of any one of claims 1 to 13 wherein applying heat and the compressive force to pressurize the composite raster and reduce void content comprises consolidation or filling out gaps within the composite raster.

16. The method of any one of claims 1 to 13 wherein applying heat and the compressive force to pressurize the composite raster and reduce void content comprises filling out gaps between the composite raster and surfaces surrounding the composite raster.

17. The method of any one of claims 1 to 16 wherein:
the consolidation tool comprises a controllable force actuator such as a pneumatic cylinder; and
the compressive force is applied using the force actuator.

18. The method of any one of claims 1 to 16 wherein:
the consolidation tool comprises a heated tip and a heating element configured to heat the heated tip.

19. The method of any one of claims 1 to 18 wherein:
depositing the composite raster comprises:
depositing a first composite raster, and
depositing a second composite raster; and
running the consolidation tool over the deposited composite raster comprises:
running the consolidation tool over the first composite raster before the second composite raster is deposited.

20. The method of any one of claims 1 to 18 wherein:
depositing the composite raster comprises:
depositing a first composite raster, and
depositing a second composite raster; and
running the consolidation tool over the deposited composite raster comprises:
running the consolidation tool over the first composite raster after the first and second composite rasters are deposited.

21. The method of any one of claims 1 to 18 wherein:
depositing the composite raster comprises:
depositing a first composite raster on a first deposition surface, and
depositing a second composite raster on a second deposition surface; and
running the consolidation tool over the deposited composite raster comprises:
running the consolidation tool over the first composite raster on the first deposition surface concurrent with at least some of the second composite raster being deposited on the second deposition surface.

22. The method of any one of claims 1 to 21 wherein the fiber-reinforced composite comprises a continuous fiber composite.

23. The method of any one of claims 1 to 22 wherein the fiber-reinforced composite comprises fiber lengths greater than a contact length of a tip of the consolidation tool.

24. The method of any one of claims 1 to 23 wherein the fiber-reinforced composite comprises a matrix embedded with discontinuous fiber, or particulate materials.

25. The method of any one of claims 1 to 24 further comprising:
varying a velocity of the consolidation tool to produce a desired level of crystallinity in a thermoplastic matrix.

26. The method of any one of claims 1 to 25 further comprising:
varying a temperature of the consolidation tool to produce a desired level of crystallinity in a thermoplastic matrix.
